(19) United States
(12) Patent Application Publication
(10) Pub. No.: US 2023/0160603 A1
(43) Pub. Date: May 25, 2023

(54) MULTI-MODES AIR HANDLING SYSTEM AND METHOD

(71) Applicant: LES ENTREPRISES DE DEVELOPPEMENT DURABLE ENERGIE, Sherbrooke (CA)

(72) Inventors: Gabriel Gagne-Marcotte, Sherbrooke, (CA); Martin Bernier, St-Francois-Xavier-de-Brompton, QC (CA); William Chabot Labbe, Gatineau, QC (CA); Alexia Mahlig, Sherbrooke (CA); Aleksandra Grgurevic, Sherbrooke (CA); Adam Fregeau, Granby (CA); Stephane Pilette, Montreal, (CA); Daniel Rousse, Quebec (CA); Pierre-Alexandre Morin, Sherbrooke (CA); Nicolas Henri, Sherbrooke (CA)

(21) Appl. No.: 17/904,019

(22) PCT Filed: Feb. 11, 2021
(86) PCT No.: PCT/CA2021/050148

§ 371 Date: Aug. 11, 2022

Related U.S. Application Data
(60) Provisional application No. 62/972,818, filed on Feb. 11, 2020.

(51) Int. Cl. F24F 13/14

(52) U.S. Cl. CPC F24F 13/14; F24F 2110/00

(57) ABSTRACT

The present invention relates to a multi-modes heat exchanger and air ventilation system and method. The system's different modes are possible with the rotation of fan assemblies allowing airflow into specific ducts, thus acting both as fans and as valves. Each air handing unit is connected to a centralized network which allows the control of multiple units simultaneously in response to interior or exterior air characteristics.

### CROSS-REFERENCE TO RELATED APPLICATIONS

The present patent application claims the benefits of priority of U.S. Provisional Patent Application No. 62/972,818, entitled “MULTI-MODES AIR HANDLING SYSTEM AND METHOD” and filed at the United States Patent and Trademark Office on Feb. 11, 2020, the content of which is incorporated herein by reference.

### FIELD OF THE INVENTION

The invention relates to the field of air handling units (AHU). More particularly, the invention relates to the field of AHU having multi-modes fans and to methods of simultaneously controlling airflows in multiple zones.

### BACKGROUND OF THE INVENTION

Nowadays, most current air handling units used in commercial or agricultural buildings rely on conventional components mostly unchanged for many years. Generally, systems comprise dampers, filters and coils connected to a centrifugal fan adapted to heat the outside air before such air enters a controlled zone. Typically, such components are bulky, not only due to their individual volume but also due to the required space for ductworks and other complemental secondary components insuring the good function of the unit.

When necessary, the airflow may be redirected inside the unit using components such as valves, traps, etc. In some smaller or more technologically advanced units, the fan itself, such as an Electronically Commutated (EC) fan, may change the direction of its airflow by changing the rotation of its fins. The inversion of rotational movement, especially if executed in a short period of time, may require a lot of energy from the motor. Nowadays, the aerodynamic properties of fan blades are generally designed to be optimized to produce an efficient airflow in one rotational direction. Thus, reversing a fan is typically inherently inefficient and would thus amount to a high energy consumption. Due to the sheer amount of such units being used in various commercial or agricultural buildings all over the world, finding and applying a more energy and space efficient system and/or method to control and change the airflow direction would amount to tremendous costs savings. Accordingly, there is a need for a method and device that regulates one or multiple zones' air characteristics with an energy efficient mode change.

### SUMMARY OF THE INVENTION

The shortcomings of the prior art are generally mitigated by multi-modes heat exchanger and air ventilation system.

In one aspect of the invention, a multi-modes air handling unit (AHU) is provided. The AHU comprises a heat-exchanging unit in seamless fluid communication with a warm airflow and a cold airflow and comprises one or more plurimodal pivoting fans. The AHU may further comprise a controller in communication with a network, the controller being configured to receive requests from remote computerized devices, such as computers, smart phones, tablets, or the likes. The controller may further be configured to regulate characteristics of a zone upon receiving such requests.

In one aspect of the invention, the AHU may comprise heating, cooling, ventilation, and air control functions. Understandably, while the embodiments described herein control air, other embodiments controlling any type of fluid are within the scope of the present invention.

In another aspect of the invention, the heat-exchanging unit may be a heat-exchanging block. A heat-exchanging block is typically made of a plurality of parallel plates positioned to receive a first airflow in a first direction and to receive a second airflow in a second direction without being in contact with each another. The first airflow comprises mostly cold air and the second airflow comprises mostly warm air. Each airflow enters through a first surface and leaves on respective opposite surfaces, the first airflow entering through a surface adjacent to the surface entered by the second airflow.

In yet another aspect of the invention, at least one fan may be located at a junction of multiple airflow passages. The fan may be a directional fan adapted to be axially rotated, such as any type of fan displacing air in a unilateral direction. The fan is mounted inside a conduit on a pivoting bracket allowing at least a rotation of 90 degrees. The rotation may be powered by at least a motor. The motor may be positioned over and/or under the center point of gravity of the fan. The fan brackets may be egg-shaped and may comprise an opening at each of two extremities, each opening being fluidly connected by a passage allowing air to flow from a first extremity to the second extremity. The fan and/or associated mount are/is adapted to allow airflow from a first conduit while blocking airflow from a second conduit, thus acting as a fan and a airflow control. Each opening may be adapted to be hermetically sealed from the second conduit when allowing airflow from the first conduit, and vice-versa. The sealing generally aims at providing contact between the housing of the AHU and the fan mount at all times, even when pivoting in-between modes. By sealing the passage from other conduits, only one airflow goes through the fan.

In some embodiments, the AHU comprises a housing. In such embodiments, the egg-shaped fan may freely pivot or rotate within the housing. The brackets may allow removing the pivoting fan from the housing or from the AHU, such as for maintenance or replacement purposes. In other embodiments, the fan brackets may have cylindrical, spherical or any other shape allowing fitting and rotation of the fan.

In another other aspect of the invention, an AHU comprises two pivoting fans and may provide up to four different modes of operation. Indeed, a first mode of operation provides one fan blowing air out of a zone into the heat-exchanging unit while the other fan is blowing air from the heat-exchanging unit to the said zone. A second mode of operation provides a fan blowing air out of a zone or an area without directing air toward the heat-exchanger unit. A third mode of operation provides a fan directly blowing air into a zone, without directing air toward the heat-exchanger unit. Finally, a fourth mode of operation provides a fan blowing air directly into a zone while the other fan blows air directly out of the zone, without directing air toward the heat-exchanging unit. It is to be understood that, independently of the chosen mode, each fan may direct air into each airflow passage of its junction; into the heat-exchanging unit, out of the heat-exchanging unit, into the controlled zone and out of the controlled zone.

In another aspect of the invention, a defrosting/de-icing and/or cleaning apparatus on a heat-exchanging block is provided. The apparatus is attached to a housing adapted to be displaced from one side of the block to the other. The apparatus may be moved using a worm screw driven by a motor assembly. The apparatus is maintained on adjacent surfaces of the block. Typically, the defrosting and de-icing unit is mounted near a cold air inlet of the heat exchanger and the cleaning unit is located adjacent to a hot air inlet. The cleaning unit may be supplemented with a phage dispenser.

In yet another aspect of the invention, a method for regulating a zone by controlling one or more AHUs with the help of a network is provided. In some embodiments, the method comprises a computerized device receiving data from sensors, meteorological data, and pollution alerts. The data may be associated to one or more zones. The received data is analysed by a computerized device. In some embodiments, the calculated actions are sent as requests to each AHU unit.

In another aspect of the invention, a fan assembly is provided. The fan assembly comprises a first conduit, a housing pivotally attached in the conduit, the housing comprising an intake passage and an outtake passage, and a fan unit mounted to the housing. In a first mode, the housing is pivotally oriented to create a first air flow in the first conduit and in a second mode, the housing is pivotally oriented to substantially limit the air flow in the first conduit. In the second mode, the housing may also block the air flow in the first conduit. In the second mode, the housing may sealingly block the air flow in the first conduit. The fan assembly may further comprise an enclosure housing the first conduit, the enclosure possibly comprising a plurality of detachable sections. In a third mode, the housing is pivotally oriented to create a third air flow in the first conduit in an opposite direction to the first air flow.

The fan assembly may comprise a second conduit, wherein in the first mode, the housing further substantially limits air flow in the second conduit and in the second mode, the housing creates a second air flow in the second conduit. In the first mode, the housing may block air flow in the second conduit and in the second mode, the housing may block the air flow in the first conduit. In the first mode, the housing may sealingly block the air flow in the second conduit and in the second mode, the housing may sealingly block the air flow in the first conduit.

The fan assembly may comprise an enclosure housing the first and second conduits. The enclosure may further comprise a plurality of detachable sections. In a third mode, the housing is pivotally oriented to create a third air flow in the first conduit, the third airflow being opposite to the first air flow. In a fourth mode, the housing is pivotally oriented to create a fourth air flow in the second conduit, the fourth airflow being opposite to the second air flow. The fan unit may be located at an intersection between the first and the second conduit.

The fan assembly may comprise at least one gas sensor, the sensor being attached to the fan unit, the gas sensor detecting one or more gases characteristics. The gas sensor may be an electronic nose. The housing may have a curved shape.

The fan unit may further comprise a pivoting mechanism to pivot the housing in relation to the first conduit. The fan unit may further comprise a controller for activating and deactivating the pivoting mechanism. The controller may be programmed to control the rotation position of the pivoting mechanism. The fan assembly may further comprise an engagement mechanism for engaging yet disengaging the pivoting mechanism. The engagement mechanism may be a manual clutch.

The pivoting mechanism may comprise one or more limit switch configured to detect the current radial position of the housing. The fan unit may be a centrifugal fan or an axial fan. The housing may be rotomolded.

In another aspect of the invention, a multi-mode air handling unit (AHU) between a first zone and a second zone is provided. The AHU comprises a structure, a heat exchanger, a first fan assembly and a second fan assembly attached to the structure, each of the fan assemblies comprising a first and a second intersecting conduits, the first conduit being in fluid communication with a first zone and the heat exchanger and the second conduit being in fluid communication with the first zone and the second zone, a housing pivotally attached at the intersection of the first and second conduits, the housing comprising an intake passage and an outtake passage, and a fan unit mounted to the housing, the housing being pivotally orientable to alternatively create a first air flow in the first conduit, and a second air flow in the second conduit.

The first and second fan assemblies may be adjacent to one another. The structure may have a first surface in contact with the first zone and a second surface in contact with the second zone. The structure may comprise recesses adapted to be coupled to forks of a vehicle. The first zone may be an enclosed area and the second zone is outside.

The pivoting of the housing of the first fan assembly may be independent of the pivoting of the housing of the second fan assembly. The relative position of each of the housing of the first fan assembly and of the second fan assembly may allow distinct operating modes of the AHU. Each of the first fan assembly and of the second fan assembly may pivot to create a direct airflow between the first and the second zones.

Each of the fan assemblies may be removable from the AHU. The AHU may be configured to be installed in a flush configuration with the wall of the first zone supporting the AHU.

In another aspect of the invention, a method for alternating between a first air flow mode and a second air flow mode is provided. The method may comprise pivotally orienting a housing in relation to a first conduit to create a first air flow in the first conduit, the housing comprising a fan unit and pivotally orienting the housing to limit or block the first air flow in the first conduit.

The method may comprise pivotally orienting the housing in the first conduit to create a third air flow, the third air flow being opposite to the first air flow. The method may comprise pivotally orienting the housing to create a second air flow in a second conduit while limiting the first air flow in the first conduit. The method may further comprise pivotally orienting the housing in the second conduit to create a fourth air flow, the fourth air flow being opposite to the second air flow.

In another aspect of the invention, a method for controlling distinct modes of operation of an air handling unit (AHU) based on control parameters between two zones is provided, the method comprising a controller receiving control parameters from one or more capturing devices of the AHU, the controller determining a mode of operation of the AHU based on the received control parameters, and automatically pivoting at least one fan unit in relation to a conduit of the AHU to create or block an air flow in the conduit based on the determined mode of operation.

The method may further comprise automatically pivoting a second fan unit in relation to a second conduit of the AHU to create or block an air flow in the conduit based on the determined mode of operation.

The first zone further may comprise the controller receiving data from an external data source. The data from the external data source may comprise any one of the followings: meteorological data, radioactive data, air quality data and contamination data.

The method further may comprise training an artificial intelligence algorithm using the captured control parameters and using the trained artificial intelligence algorithm to determine the mode of operation of the AHU. The training of the artificial intelligence algorithm may comprise providing feedback from one or more user of the AHU.

The capture of the control parameters may comprise any one of the followings: measuring temperature, detecting virus or bacteria present in the air, measuring humidity level, sensing odors, detecting type of gas or presence of particles in air, such as carbon level.

In another aspect of the invention, a system for ventilating a building comprising multiple zones, each zone comprising a least one air handling unit (AHU), each AHU being configured to execute a method for controlling distinct modes of operation of an air handling unit (AHU) based on control parameters between two zones. The system may be used in an agricultural building. In another aspect, each zone may be a predetermined zone in an open area.

Each of the AHUs may be in data communication with one another. Each of the AHU may be controlled by a server.

The features of the present invention which are believed to be novel are set forth with particularity in the appended claims. Other and further aspects and advantages of the present invention will be obvious upon an understanding of the illustrative embodiments about to be described or will be indicated in appended claims, and various advantages not referred to herein will occur to one skilled in the art upon employment of the invention in practice.

Other and further aspects and advantages of the present invention will be obvious upon an understanding of the illustrative embodiments about to be described or will be indicated in the appended claims, and various advantages not referred to herein will occur to one skilled in the art upon employment of the invention in practice.

### BRIEF DESCRIPTION OF THE DRAWINGS

The above and other aspects, features and advantages of the invention will become more readily apparent from the following description, reference being made to the accompanying drawings in which:

FIG. 1 is a perspective view of an embodiment of an AHU in accordance with the principles of the present invention.

FIG. 2 is an exploded view of the AHU of FIG. 1.

FIG. 3 is a sectional view of a cavity of the AHU of FIG. 1.

FIG. 4 is a side sectional view of the AHU of FIG. 1.

FIG. 5 is a perspective view of a fan assembly of an AHU in accordance with the principles of the present invention.

FIG. 6 is a sectional view of a junction of a housing of a fan assembly and of a conduit of an AHU in accordance with the principles of the present invention.

FIG. 7 is a top sectional view of the AHU of FIG. 1.

FIG. 8 is a front plan view of the fan assembly of FIG. 5 shown in a first mode of operation.

FIG. 9 is a top sectional view of the fan assembly of FIG. 8 about the A-A axis.

FIG. 10 is a front plan view for the fan assembly of FIG. 5 shown in a second mode of operation.

FIG. 11 is a top sectional view of the fan assembly of FIG. 10 about the B-B axis.

FIG. 12 is a top sectional view of the AHU of FIG. 1.

FIG. 13 is an illustration of an embodiment of control components of an AHU in accordance with the principles of the present invention.

FIG. 14 is an illustration of a system for regulating airflow in multiple zones.

FIG. 15 is a front perspective view of an embodiment of an AHU in accordance with the principles of the present invention.

FIG. 16 is a back perspective view of an embodiment of an AHU in accordance with the principles of the present invention.

FIG. 17 is a perspective view of an embodiment of an AHU in accordance with the principles of the present invention shown mounted in a wall and viewed from a first zone.

FIG. 18 is a perspective view of the AHU of FIG. 17 viewed from the second zone.

FIG. 19 is a side elevation section view of the AHU of FIG. 17 viewed from within the wall.

### DETAILED DESCRIPTION OF THE PREFERRED EMBODIMENT

A novel multi-modes air handling unit or heat exchanger and air ventilation system and method will be described hereinafter. Although the invention is described in terms of specific illustrative embodiments, it is to be understood that the embodiments described herein are by way of example only and that the scope of the invention is not intended to be limited thereby.

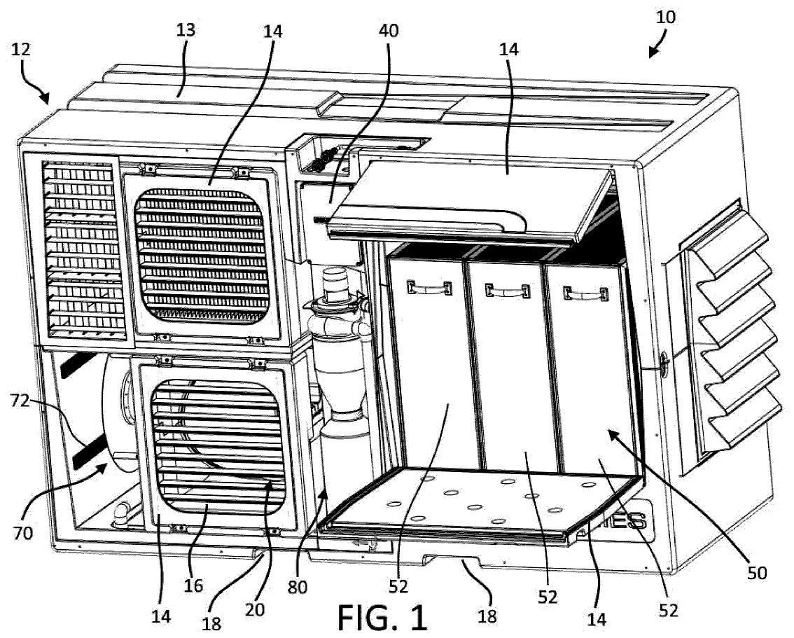

Referring now to FIG. 1, an embodiment of an air handling unit (AHU) 10 is illustrated. In such an embodiment, the AHU 10 comprises a structure or a frame 12, one or more pivoting fan assemblies 20, a heat-exchanging unit 50. The AHU may further comprise a controller 40. In some embodiments, the AHU 10 may further comprise a filtering system 70 and a vacuum system 80.

The AHU 10 is generally positioned between two zones. In some embodiments, a first zone is in a controlled environment, such as a zone inside of a building, and a second zone is in a non-controlled environment, such as outside or exterior area, such as but not limited to the outside area of the building. In some embodiments, the AHU 10 comprises removable panels or doors 14. The removable panels 14 are typically attached to the structure 12 of the AHU 10. The AHU 10 may comprise a housing 11 adapted to protect the AHU 10 against the external elements, such as snow, rain, etc. The housing 11 is typically attached to the structure 12. The housing 11 may further comprise an outer casing 13 generally aiming at protecting and isolating inner components of the AHU 10 in relation to the first and second zones. The AHU 10 may further comprise conduits or ductworks 16 fluidly connecting the first zone, each pivoting fan assembly 20 and the second zone.

In some embodiments, the structure 12 of the AHU 10 may further comprise notches, recesses or other shapes 18 adapted to receive forks of a vehicle, such as a tractor. When forks are inserted under and/or in the notches 18, the AHU 10 may be moved, raised, lowered and manipulated with a vehicle. Using a vehicle may ease the installation of the AHU 10 in an opening of the building as the vehicle may align the AHU 10 with the opening and lower the said AHU 10 on an inner wall of the opening.

In yet other embodiments, the AHU 10 and/or structure 12 is adapted to have a flush fit with a wall or with the edges of the opening in which the AHU 10 is mounted. The flush fitting generally aims at reducing the occupied volume of the AHU 10 in one of the zones, typically the zone within the building. The flush fit generally implies having duct or conduit 16 and/or other components of the AHU 10 being positioned toward the other zone, typically outside the building.

In a typical embodiment, in a first mode, a fan assembly 20 is adapted to pull or drive air from the first zone through a first inlet and to blow the air towards an outlet in connection to the second zone, thus forming a first conduit 2. In the first mode, the fan assembly 20 or fan unit 22 is oriented in the general longitudinal direction of the conduit 2. In a second mode, the fan unit 22 or fan assembly 20 is pivoted or oriented to block air flowing in the first conduit 2. In a preferred embodiment, the fan unit 22 or fan assembly 20 is pivoted about 90 degrees from the longitudinal direction of the first conduit. In some embodiments, the air from the first zone is blown by the fan assembly 20 toward the heat exchanger unit 50 in the second mode.

In a third mode, the fan assembly 20 is oriented to pull or blow air from the second zone towards the first zone, thus using the first conduit 2 in an opposite direction to the first mode. Typically, in the third mode, the fan assembly 20 is pivoted about 180 degrees from the first mode. In a fourth mode, the fan assembly 20 is adapted to block air in the first conduit 2 and to form the second conduit 4. Preferably, in the fourth mode, the fan assembly 20 is pivoted about 270 degrees or −90 degrees from the position of the first mode. In the fourth mode, the air is preferably blown by the fan assembly 20 from the heat exchanger unit 50 towards the first zone.

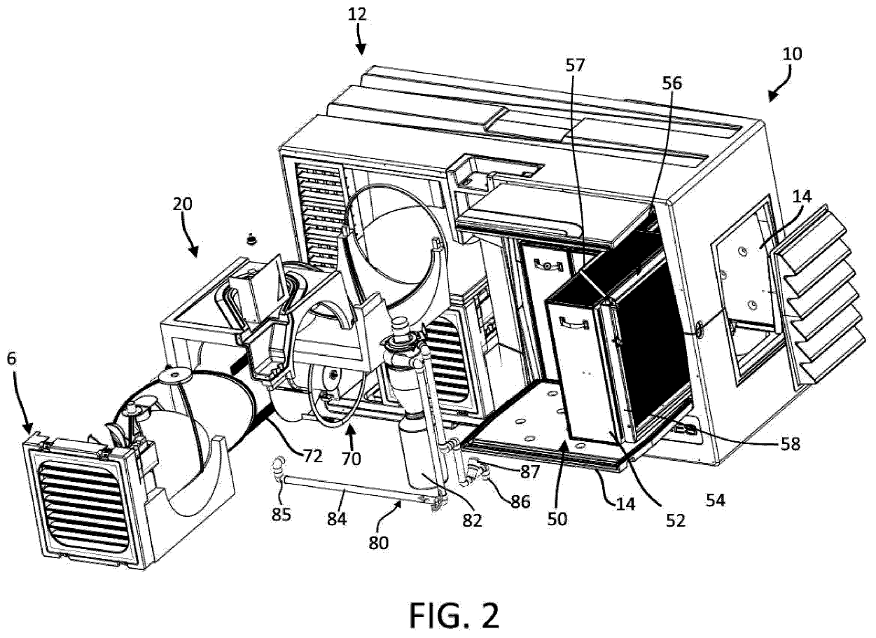

Referring now to FIG. 2, an exploded view of the AHU 10 of FIG. 1 is shown with components singled out. As shown, some components of the AHU 10 are removable or at least displaceable, aiming at easing the access to the components by a user.

In some embodiments having a filtering system 70, the filtering system may be slideably attached to the structure 12 of the AHU 10. In yet other embodiments, the filtering system 70 is mounted to at least one set of rails 72 which are attached to the structure 12. The rails 72 allow the filtering system 70 to move at least partly in and out of the AHU 10. As the filtering system 70 is moved out, it may be serviced or maintained.

In yet other embodiments, the one or more fan assembly 20 may be detachable from the AHU 10. In such embodiments, the fan assembly 20 is part of an external housing or casing 6 which may slide in and out of the structure 12 or housing 11 of the AHU 10. The fan assembly 20 may be fastened to the AHU 10 when inserted. In such embodiment, the housing 11 or structure 12 comprises a surface or rails to slidably receive the fan assembly 20.

In embodiments comprising a vacuum system 80, the housing 11 or structure 12 of the AHU 10 may comprise an access door, panels or trap 14 covering the vacuum system 80. The access door 14 aims at providing access for maintenance or service of the vacuum system 80 or other adjacent components. Understandably, any other known mechanism to cover yet access the vacuum system 80 may be used within the scope of the present invention.

In further embodiments, the AHU 10 may further comprise one or more doors 14 to access one or more components, such as cassettes or blocs, a heat-exchanger, a fluid drain, a heater, an air conditioning unit, etc. When the one or more doors 14 are opened, each of the components may be pulled out or tilted to be accessed. As an example, the heat-exchanging unit 50 may be entirely removed or may one or more the cassettes 42 may be independently removed. Furthermore, one or more of the fan assemblies 20 may be taken out of the AHU 10, such as for maintenance or replacement purposes. The doors 14 may be embodied as sliding doors, pivoting doors or spring-loaded doors. Understandably, the components may be fastened or mounted to the structure 12 or the housing 11 and may be further adapted to be accessible during operation. The components may further be installed or uninstalled when the AHU 10 is mounted in the aperture of the building. In some embodiments, the AHU 10 may comprise doors 14 on the surface within the first zone and corresponding doors 14 on the surface facing the second zone. As such, one may service or maintain the AHU 10 while being in the first zone, typically inside the building, or while being in the second zone, typically outside.

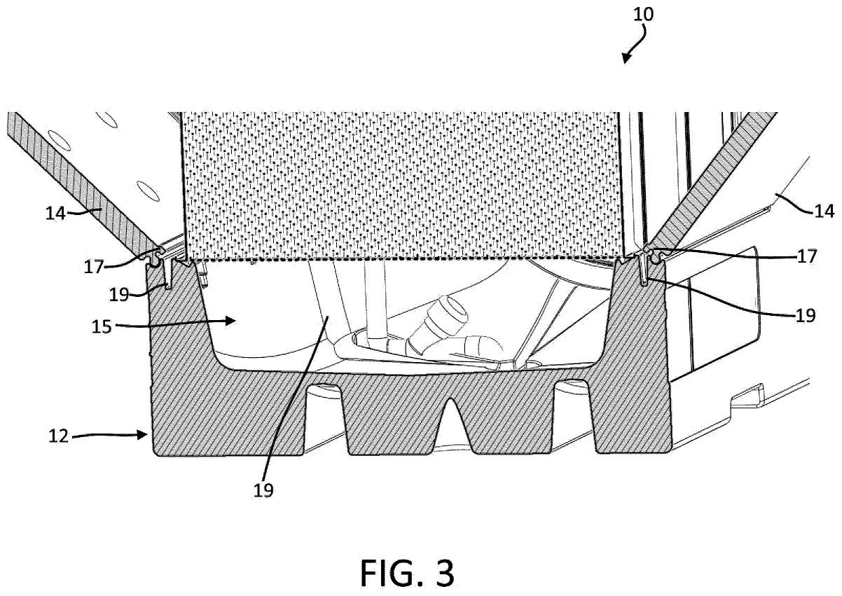

Now referring to FIG. 3, the housing 11 or the structure 12 of the AHU 10 may comprise a cavity or enclosure 15, typically located under the different components, such as the heat-exchanger 50. The cavity 15 may comprise seal joints 17, typically between the hinge of the doors 14 and the cavity 15. The joints 17 generally provide a barrier for the liquid to exit the cavity 15 through such openings. The structure 12 or the cavity 15 of the AHU 10 may comprise a plurality of recesses, angled surfaces, or paths 19. The recesses 19 are generally adapted to capture the liquid flowing in the cavity 15 and to direct the said liquid toward a drain or liquid discharge. In the shown embodiment, the drain is located on the bottom surface of the cavity 15, preferably around the center of the said bottom surface which form a low point. Understandably, any other arrangement of recesses, angled surfaces and/or paths 19 allowing the flow of liquid towards a drain or an opening are within the scope of the present invention.

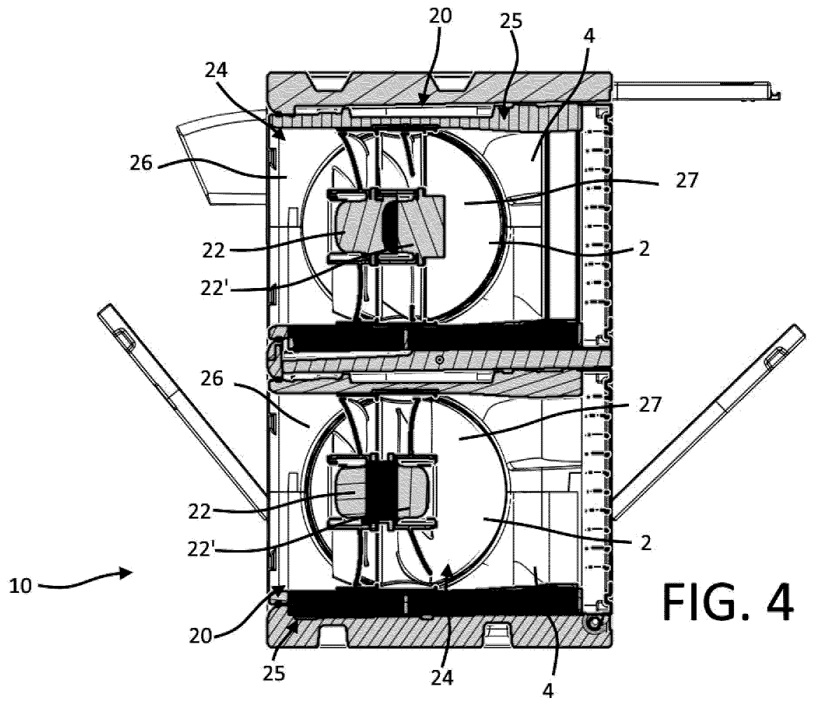

Now referring to FIG. 4, an embodiment of the fan assembly 20 is illustrated. The fan assembly 20 comprises a first conduit 2, a housing 24 pivotally attached in the conduit 2, and a fan unit 22 mounted to the housing 24. The housing 24 typically comprise an intake passage or opening 26 and an outtake passage or opening 27. The fan assembly 20 may further comprise a pivoting member 28. In such embodiments, the pivoting members 28 pivots or orients the housing 24, not shown. In other embodiments, the fan assembly 20 may comprise two fans or propellers (22, 22′). The two fans 22, 22′ may be installed in series and may be pivoted using the same pivoting member 28. It may be appreciated that having two fans (22, 22′) in the fan assembly 20 generally aims at increasing the air pressure to provide an improve airflow per fan assembly 20 over fan assemblies 20 having a single propeller. It may further be appreciated that having two fans (22, 22′) in the fan assembly 20 generally allows the fan assembly 20 to remain functional in the event where one of the two fans (22, 22′) is defective. The fans (22, 22′) of the assembly 20 may be any type of fan known in the art, such as but not limited to an axial fan or a centrifugal fan.

The fan unit 22 typically comprises a propeller and motor. The fan unit may further comprise an integrated controllers or a switch to activate yet deactivate the fan unit.

The fan assembly 20 further comprises a conduit 2 in fluid communication with a zone or with a heat exchanger 50. The conduit 2 may be integrated or moulded into an enclosure 25 of the fan assembly 20. The conduit 2 is typically formed or moulded in the enclosure 25 of the fan assembly 20. The conduit 2 may be an extension of the ductworks 16. Therefore, the conduit 2 is typically the convergence of the multiple air paths if there is more than one conduit 2 for a given propeller 22.

In some embodiments, the fan assembly 20 comprises two intersecting conduits (2, 4). The two conduits (2, 4) may intersect at an angle, preferably the angle being around 90 degrees. Understandably, in other embodiments, the two conduits (2, 4) may intersect at different angles, such as but not limited to 60 degrees and 120 degrees or 45 degrees and 135 degrees. Additionally, the conduits (2, 4) may converge within any plane, such as but not limited to a horizontal plane or a vertical plane. As an example, two conduits (2, 4) may intersect at 60 degrees from each another.

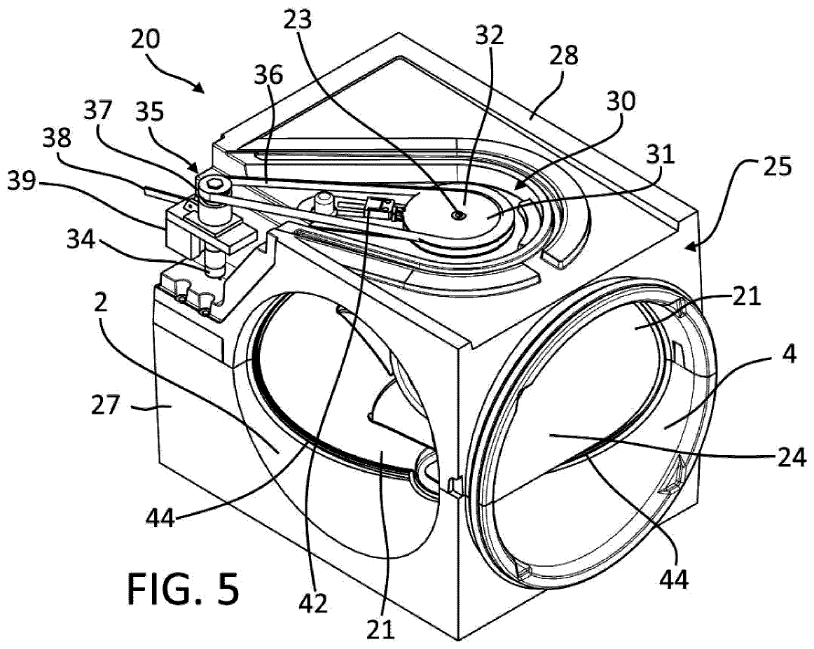

Now referring to FIG. 5, the enclosure 25 may be made of multiple sections and may have a plethora of shapes. In the present embodiment, the enclosure 25 is made of a bottom 27 and a top portion 28. In other embodiments, the enclosure 25 may be made of more than two sections or may be unitary. The different configuration generally aim at easing production, assembly and/or disassembly. The enclosure 25 may further be made of plastic or be moulded. The enclosure 25, and various other components of the AHU 10, may be rotomolded. Furthermore, the shape, length and overall configuration of the conduits (2, 4) may vary according to the space available in the AHU 10 or the configuration of the AHU 10 or of the building. In such an embodiment, the conduits (2, 4) are shaped as a 90 degrees elbow. Understandably, in yet other embodiments, the said conduits (2, 4) may have any configuration based on the selected configuration of the AHU 10.

The housing 24 of the fan assembly 20 is pivotally mounted to the enclosure 25, preferably using a pivoting mechanism 30. The pivoting mechanism 30 may comprise a pivoting member 32 which may activated by a motor 34. The pivoting member 32 orients or pivots the housing 24 around a substantially vertical axis 23. The pivoting member 32 may be embodied as a pivoting device or a bracket connected to a pivoting device adapted to rotate the pivot axis 23.

In some embodiments, the pivoting mechanism 30 comprises a servomotor 33, not shown, and a pivoting member 32. The servomotor 33 is configured to control the rotation of the pivoting member 32, thus controlling the orientation of the fan assembly 20. The pivoting member 32 is operatively connected to the housing 24. As the fan unit 22 is mounted in the housing 24, the air flow is rotated accordingly. The housing 24 is typically pivotally mounted to the enclosure 25 through a central axis 23 of the housing 24, allowing the housing 24 to rotate around itself or around the vertical axis 23. Understandably, in other embodiments, the pivoting member 32 may be adapted to allow pivoting around a generally horizontal axis if conduits (2, 4) are adapted accordingly. Having another axis of rotation may allow the implementation of vertical conduits 16 which may thus be greatly beneficial in applications having limited space.

In yet other embodiments, the pivoting mechanism 30 may be operatively connected to or in communication with a controller 40. The controller 40 may be configured to activate and/or deactivate the pivoting mechanism 30. The controller 40 may be further configured or programmed to control the radial/rotational position, the speed of rotation and/or the direction of rotation of the pivoting mechanism 30. Understandably, the controller 40 may be a component of the AHU 10 or be embodied as an external module.

The fan assembly 20 may further comprise an engagement mechanism 35 for engaging yet disengaging the pivoting mechanism 30 of the fan assembly 20 or fan unit 22. In some embodiments, the embodied engagement mechanism 35 is a clutch system allowing the engagement and disengagement of the pivoting mechanism 30. In such embodiments, the fan assembly 20 comprises a drive mechanism 36 engaged by the engagement mechanism 35 and driving the pivoting mechanism 30. The drive mechanism 36 may comprise a drive belt or chain engaging the pivoting member 32 and a spline 37 of the clutch system 35. The spline 37 may move vertically to engage yet disengage a rotation mechanism 34. The rotation mechanism 34, generally a motor, may rotate a drive shaft in either direction. A pivoting handle 38 may further be connected to the spline 37 to raise or lower said spline 37. The pivoting handle 38 may allow a user to manually disengage the motor 34 to the spline 37 when required.

The fan assembly may further comprise a tensioning system 39. The tensioning system 39 may be slidably connected to the clutch system 35. The tensioning system 39, by translating the clutch system 35 away or towards the pivoting mechanism 30, increases or lowers the tension in the drive belt 36. Understandably, the rotation mechanism 34 and the tensioning system 39 may be controlled by the controller 40.

The fan assembly 20 may further comprise at least one limit switch 42 configured to detect the current radial position of the housing 24 and to communicate the said position to the controller 40. In the embodiment shown, two limit switches 42 are configured to be in contact with disks 31 of the pivoting mechanism 30. Accordingly, the disks 31, typically embodied as a pulley, of the pivoting mechanism 30 may comprise disturbances, such as embosses or recesses, not shown, on the surface or at the periphery of the disk 31. When the disk 31 is turning, the disturbances contact the limit switches 42, thus activating one of the said limit switches 42. The activation or deactivation of a limit switch 42 indicates that the housing 24 is pivoted to a predetermined position, such as pivoted 90 degrees or 270 degrees, etc. Understandably, other systems may be used to determine the position of the disk 31, such as a position encoder.

The housing 24 comprises side walls 21 alternatively positioned between apertures or inlet/outlet. The side walls 21 are generally sized to at least partially block air from one of the conduits (2, 4). In other embodiments, the side walls 21 may completely block the airflow of one of the conduits (2, 4) while the apertures allow the airflow from the fan unit 22 to circulate in the other conduit (2, 4). The housing 24 is generally shaped to allow pivoting movements of the fan unit 22 within the conduits (2, 4), preferably at the intersection of the conduits 23.

In the present embodiment, the side walls 21 are curved. The curved side walls 21 generally provide a rounded, oval or egg shape to the housing 24. In some embodiments, the housing 24 has a rounded shape or has rounded edges to ease the pivoting. Understandably, any other shape allowing pivoting and sealing functions may be used, such as cylindrical, oval, round or even square.

The side wall 21 may further comprise a ledge or lip at the periphery. Such ledge or lip typically aims at increasing the rigidity of the side wall 21 and/or to seal the inlet/outlet aperture when contacting a seal 44 of the said aperture or of the conduit 2.

In an embodiment, the housing 24 may be taken out of the enclosure 25 or conduits (2, 4) without disassembling the entire conduits (2, 4) or enclosure 25. Similarly to the enclosure 25, the housing 24 may further comprise more than a pair of side walls 21. As an example, the housing 24 may comprise a top section and a bottom section.

The housing 24 may further comprise sealing means 44, such as a rubber band or other sealing material allowing efficient blocking of air between the walls 21 and the conduits (2, 4). The sealing means 44 generally surrounds the openings of the housing 24, such as the inlet and/or outlet. The sealing band 44 may also be attached to the edges of the side walls 21 to block air at the junction of the side walls 21 and the conduits (2, 4) or enclosure 25. h. Understandably, any type of sealing means blocking the air from one conduit in conjunction with the side walls 21 may be used within the scope of the present invention.

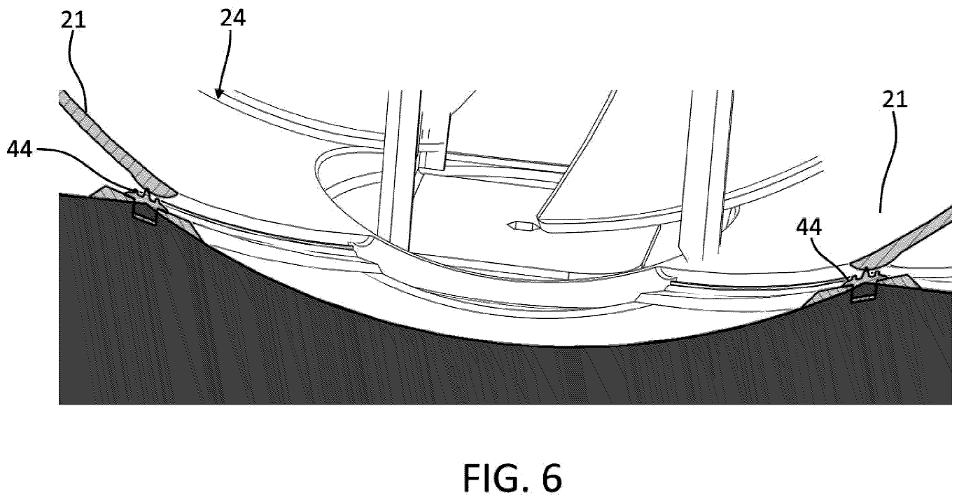

Referring now to FIG. 6, a sectional view of the junction between the housing 24 of a fan assembly 20 and the conduit (2, 4) or enclosure 25 is illustrated. When the housing 24 is positioned to create an airflow in one conduit (2, 4), the side walls 21 of the housing 24 may be sealingly connected to a sealing joint 44 located on the periphery of the junction between the conduit (2, 4) or the enclosure 25 and the housing 24. Accordingly, the airflow present in the conduit (2, 4) does not leak or is substantially maintained within the fan unit 22 with the said conduit. The sealing joint 44 may be made of any sealing material known in the art.

In yet other embodiments, the system 10 may further comprise sensors, not shown, upstream and/or downstream from each fan 22. Such sensors may be configured to analyse the airflow. In an example, the sensor detects and communicate data about the airflow or pressure of the airflow. When the airflow or pressure lowers or increases, an alert or any action may be triggered. As another example, if the airflow is lowered, the resulting data may be associated in a leak or perforation resulting in an air loss. In such an example, the fan assembly 20 or housing 24 may be disassembled to further investigate the air loss. The sensors may be gas sensors adapted to detect a variety of gases characteristics. For example, the sensors may be adapted to detect presence of bacteria and/or viruses in the airflow. The sensors may further include sensor configured to detect odors. In an embodiment, the gas sensors may be an electronic nose adapted to detect a variety of gases and odors.

In a preferred embodiment, the sensor is attached or mounted to the housing 24 of the fan assembly 22, typically on a bracket positioned in the air flow created by the fan assembly 22. As the housing 24 is pivoted, the sensor is maintained in the airflow, thus limiting the number of sensors required as the sensor always follows the airflow.

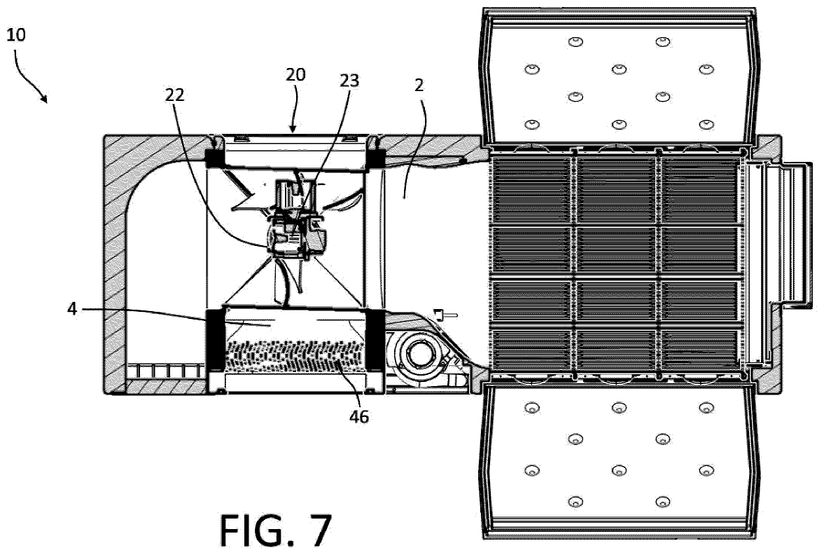

Referring now to FIG. 7, a top down sectional view of the AHU 10 is shown. In such an embodiment, the fan assembly 20 is pivoted to form the first conduit 2. In this embodiment, the air from the second zone is blown from an outlet conduit by the propeller 22 to an inlet conduit towards the first zone.

In some embodiments, the outside air passes through the heat-exchanging unit 50 before being blown by the propeller 22. While passing through the heat-exchanging unit 50, the warm air flow exchanges energy with the cold air flow, resulting in a supply airflow warmer than initially collected. A second mode requires the propeller 22 to be pivoted by 180 degrees or in opposite direction from the first mode. In such mode, the air flow moves in an opposite direction still in the first conduit 2, thus the air flows from the first zone to the heat-exchanging unit 50.

In a third and fourth mode of use, air flow may be direct from one zone directly to the other, such as without going through the heat-exchanger 50. In such modes, all the fans 22 may direct air in the same direction, both in or out of the first zone toward the second zone, or in opposite directions. In the third and fourth modes, the airflow is directed in the second conduit 4 and at least partially blocked in the first conduit 2. In order to change the mode of use, the housing 24 may rotate clockwise or counter clockwise around a central pivot point 23 until the desired position is reached.

In another embodiment of the invention, sensors may be installed at different positions in and out of the AHU 10 to detect if ice has been formed and blocks or reduces the airflow or the pivoting movement of the propeller assemblies. Fans 22 direction may be temporarily reversed in order to send warm air in an otherwise cold area until the situation is resolved.

In another mode, the housing 24 of the fan assembly 20 is pivoted or oriented within the fan assembly 20 to form the first conduit, also referred as the blower mode. The air from either the first or second zones enters an inlet portion of the first conduit, goes through the propeller assembly and is blown toward an outlet portion of the first conduit toward the second or first zones respectively.

In yet other embodiments, the AHU 10 may comprise blinds 46. The blinds 46 may be positioned between the first and/or second zone and the fan assembly 20. In yet other embodiments, the blinds 46 are installed in between shutters 48 and the fan assembly 20. The blinds 46 are typically passive and block outside light may get into the inside zone when the fan assembly 20 is oriented as such. It may especially be useful in applications wherein animals are comprised, as light may scare off some animals, such as in farming or agricultural use.

In other embodiments, the AHU 10 comprises shutters 48 at each fluid inlet and fluid outlet. The shutter 48 may be gravity driven shutters or mechanically operated shutters adapted to be open and closed by an activation mechanism, not shown. The activation of the shutters 48 may be controlled by the controller 40.

In some embodiments, the AHU 10 comprises one or more additional fan assemblies 20 either stacked horizontally or vertically with regard to the first fan assembly 20. Generally, two fan assemblies 20 may be necessary to make the heat-exchanging unit 50 function properly as two airflows of different temperatures are necessary to allow heat exchange. In such an embodiment, the two fans assemblies 20 may be pivoted to each form a second conduit 4, also referred as a blower mode. Understandably, the blower mode may be adapted to blow air from a first zone to a second zone or vice versa by pivoting the propeller assemblies 20 by 180 degrees.

As illustrated, it may be appreciated that the fan assemblies 20 may be offset from the center width-wise of the AHU 10. Offsetting the positioning of the fan assemblies 20 from the center of the AHU 10 may allow for the installation of other components inside the structure 12 rather than outside of the structure 12. For example, the offset configuration may allow the installation of the vacuum system 80 inside the structure 12 of the AHU 10 rather than outside.

In yet another embodiment, the AHU 10 may further comprise make up air unit (not shown), also known as recycled exhaust air unit. In such embodiments, the make up air unit is adapted to mix the airflow entering the AHU 10, such as the outside air, to an airflow coming from the building, typically a heated airflow. By mixing a warm airflow to the entering airflow, having a generally lower temperature, the temperature of the resulting airflow is higher than the temperature of the entering airflow.

The make up air unit generally aims at reducing the energy required to produce a warm resulting airflow. In one embodiment, the make up air unit comprises a conduit having a damper. Preferably, the conduit is fluidly connected to the docking providing the entering airflow, upstream from the heat-exchange unit 50. In yet another embodiment, the make up air unit may comprise a conduit 16 having a damper, the conduit 16 being fluidly connected to the exhausted airflow leaving the heat-exchange unit 50 and to the entering airflow upstream from the heat-exchanger unit 50. In both embodiments, the exhaust airflow has a higher temperature than the entering airflow. Understandably, the said conduits 16 and dampers may have any shape and configurations known in the art. In a further embodiment, the opening and closing of the dampers may be controlled by communicating directly with the AHU 10 through the network.

Referring back to FIG. 5, an embodiment of a fan assembly 20 is shown forming the first conduit 2. In such an embodiment, the conduit 2 comprises a first outer portion in fluid communication with the first zone and a second outer portion in fluid communication with the heat exchanger unit 50. In such embodiments, the conduit 2 is curved to allow air to be directed to the cassette section which may comprise the heat exchanger unit 50 with limited space. Understandably, in other embodiments, to optimize the flow of air and to fit within the AHU 10, the conduit 2 encompassing the housing 24 may have any other compatible shape.

The second conduit 4 generally comprises a third outer portion in fluid communication with the first zone and a fourth outer portion in fluid communication with the second zone. Such third and fourth outer portions are generally forming the second conduit 4. Other additional outer portions may be added as to form supplementary conduits. As example, a third conduit, not shown, may be connected to the bottom of a top fan assembly 20 and to the top of a bottom fan assembly 20.

In such embodiment, the fan assembly 20 comprises a housing 24. In a typical embodiment, the fan unit 22 is positioned about the junction of the first and second conduits (2, 4). In some embodiment, the housing 24 comprises a pivoting member 32 pivotally mounted to the housing 24 at a pivot point 23. In an embodiment, the pivoting member 32 may be a servomotor while in another embodiment, the pivoting member 32 may be connected to a controller 40 or to a motor (not shown) to control and/or automate the rotation of the housing 24. The pivoting member may further comprise a limit switch 42 to measure the rotation of the fan assembly 20. Understandably, any other mean to allow the fan unit 22 to pivot about the conduits (2, 4) may be used within the scope of the present invention. As examples, the motor 34 may be installed over or under the housing 24 depending on required performances and/or on available space. The housing 24 may be curved, generally aiming at allowing free rotation of the fan 22 within the conduits (2, 4) while alternatively sealing outer portions of the first conduit 2 or outer portions of the second conduit 4. Understandably, any other shape having similar functions as the above-described curved mount 24 may be used within the scope of the present invention.

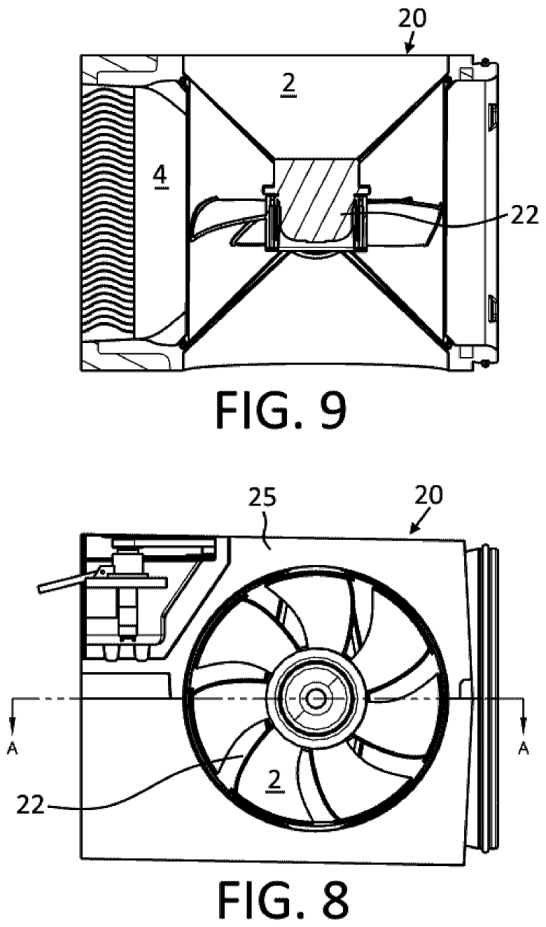

Referring now to FIGS. 8 and 9, an embodiment of a fan assembly 20 shown in a first mode of operation is shown. In such an embodiment, the fan assembly 20 is positioned in such a way as to let air flow from the interior of a first zone to the heat-exchanging unit 50, thus forming the first conduit 2. While the fan assembly 20 is positioned in the first mode of operation, the second conduit 4 is blocked and/or sealed by the side walls 21 of the fan assembly 20, thus acting as a valve.

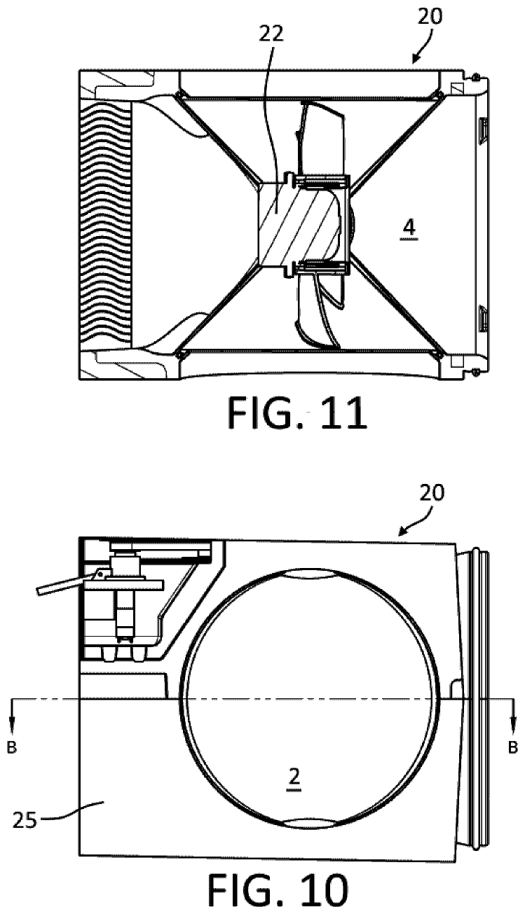

Referring now to FIGS. 10 and 11, an embodiment of a fan assembly 20 shown in a second mode of operation is shown. In such an embodiment, the fan assembly 20 is positioned to let air flows directly between the first zone and second zone (or vice-versa), thus forming the second conduit 4. While the fan assembly 20 is positioned in the second mode of operation, the first conduit 2 is blocked and/or sealed by the side walls 21 of the fan assembly 20, thus acting as a valve.

Understandably, in some embodiments, the opening may not be hermetically sealed from the second conduit 4 or first conduit 2. In some embodiments, the conduits (2, 4) or enclosure 25 may not be in contact with the housing 24, but may still block a substantial portion of the airflow.

Referring now back to FIGS. 1 and 2, an embodiment of a heat-exchanging unit 50 is illustrated. The heat-exchanging unit 50 may be any heat-exchanging unit allowing two or more airflows to exchange heat within said heat-exchanging unit 50. In the illustrated embodiment, the heat-exchanging unit 50 comprises a plurality of replaceable counter flow heat-exchanging cassettes or plate blocs 52. In such embodiment, each bloc 52 may be adjacent to another bloc 52 and/or in contact with the adjacent bloc 52, preferably through at least a dampening portion 54. The dampening portion 54 may be embodied as a frame around a side surface of a bloc 52 and is generally made of flexible or semi-flexible material, such as but not limited to rubber. The dampening surface 54 may further have heat isolating and liquid repellent properties to prevent heat or humidity to circulate between two adjacent blocs 52. The dampening surface 54 may further be configured to dampen the force applied to the adjacent surfaces of each of the blocs 52 to prevent possible breaks. It may be noted that singular blocs 52 of the heat-exchanging unit 50 may be removed from the unit independently from other blocs 52 of the same unit 50, such as for maintenance or replacement.

Understandably, over time, adjacent blocs 52 may drift apart from one another and result in leaks of heat or humidity around the heat-exchanging unit 50. The AHU 10 may further comprise a compression system 56. The compression system 56 is configured to be accessible by a user when doors 14 of the AHU are opened. In some embodiments, the compression system 56 comprises a handle 57. The handle 57 may be in pivoting connection with push bars 58 located on the heat-exchanging bloc 52. A user may thus pivot the handle 57 to press the pushing bars 58 against a side of the heat-exchanging unit 50, consequently compressing each adjacent bloc 52 against one another.

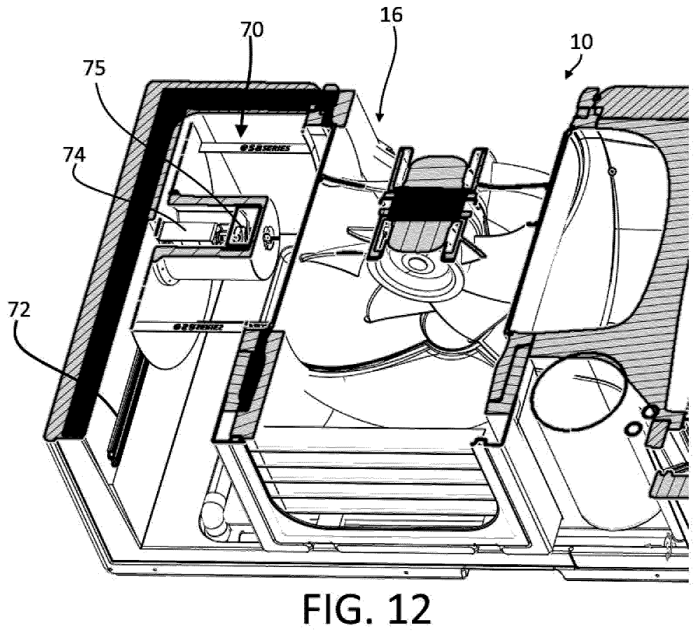

Now referring to FIG. 12, the AHU 10 may comprise filtering system 70. The filtering system 70 is configured to filter the airflow between a conduit 16 of a fan assembly 20 and a zone. Accordingly, an airflow entering or leaving the structure 12 from the external zone may pass through the filtering system 70 and get filtered. The filtering system 70 illustrated is a centrifugal filter activated by an actuator 74 located in the center of the cylindrical shape of said filter 70. It may be appreciated that the filtering system 70 may cover the entire area around the output or input of an associated conduit 16 so that no air flow may avoid being filtered. The filtering system 70 may further comprise a limit switch 75 configured to count the number of rotations of the system 70 for better tracking and/or control of the same. In some embodiments, the filtering system 70 may comprise a motor instead of an actuator to rotate the filter media. The motor 74 may be located at the center of the rotating filter media.

Back to FIGS. 1 and 2, the AHU 10 may further comprise a vacuum system 80. The vacuum system 80 may comprise a vacuum device 82, one or more pipes 84 and an outlet. The vacuum system 80 is generally configured to clean the filter system 70. In such embodiments, an inlet pipe 85 is positioned adjacent to the filter media, thus removing debris or particles from the filter while it is rotating. The vacuum system 70 may further comprise a liquid discharge pipe system 86 in fluid communication with a liquid discharge opening of the AHU. The liquid discharge pipe system 86 is configured to remove humidity or liquids from the vacuum system 70 out of the AHU 10. The vacuum system 80 or the drain may comprise one way flap or valve 87 to block the entry of air flows from outside the said liquid discharge pipe system 86. Understandably, the vacuum system 80 may be in fluid communication with other systems of the AHU 10 if required and is thus not limited to fluidly communicate with the filtering system 70 and the liquid discharge opening of the AHU 10.

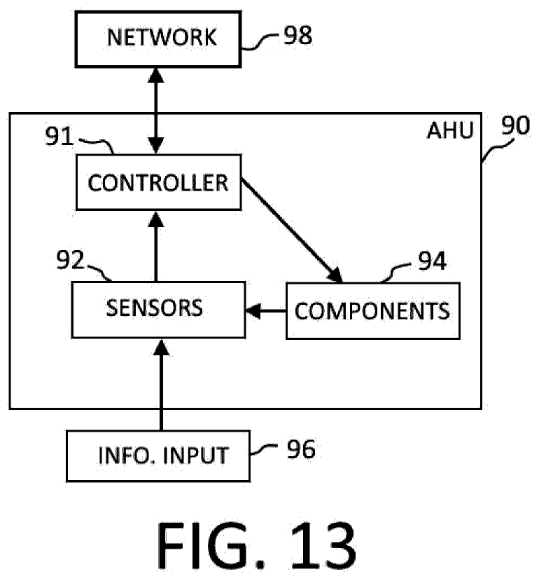

Referring now to FIG. 13, an embodiment of the control system 90 of an AHU 10 is schematically illustrated. The arrows of FIG. 13 generally represent the direction of the transfer of data between elements. The system 90 comprises sensors 92 attached to components 94 of the AHU 10, a controller 91 adapted to receive data from the sensors 92 and from external sources 96 through a network 98.

The sensors 92 is typically installed or coupled to some or all of the components 94 of the AHU 10 and are configured to collect data from operations and status of the components 94. As an example, a carbon dioxide sensor may be installed in the supply shaft of the exterior air to determine the level of carbon dioxide entering the building. Another example may be an airflow sensor installed at the intake or inlet of the AHU 10 or within exhaust ducts. The airflow sensor determines the speed of the airflow and may possible to determine if ice or debris is blocking the airflow. The sensors 92 may be configured to communicate the data to the controller 91.

The controller 91 may be embodied as any computerized device, such a controller board, a computer, or a small size computerized device. The controller 91 may be located within or outside the AHU 10. The controller is generally configured to receive data collected from the sensors 92, to process the received data and/or to calculate if the data is over some predetermined thresholds, to send or receive the received data or processed data from and to the network 98, and to communicate with the components 54. The presented order may not represent the actual sequence of operation of the controller 91 which may vary and is to be determined by the network's 98 parameters. The controller 91 is further configured to control components such as to start or stop fan assemblies 20, to actuate pivoting of the fan assemblies 20 and to adjust the speed of one or more propellers 22.

The information from external sources 96 may comprise public alerts issued by authorities or related organisms, weather information or any connection to remote systems providing data.

In some other embodiments, the controller 91 may further be configured to execute a program providing deep learning capabilities in order to identify the best behavior for simultaneous multi-zone optimal control. The identification of the best behavior may use historical data as a parameter.

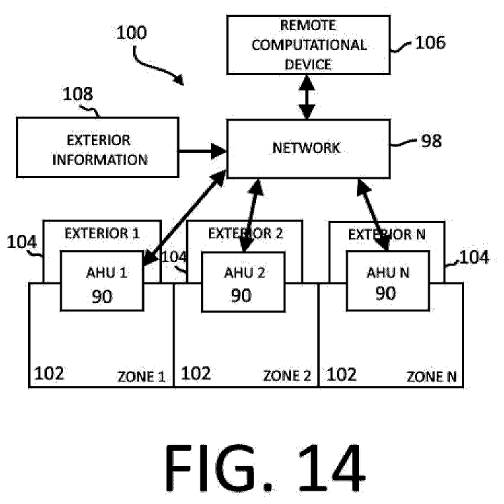

Referring now to FIG. 14, an embodiment of a system for regulating airflow in multiple zones 100 is illustrated. The system 100 comprises a plurality of AHU 10 in communication with a first zone 102 and a second zone 104, each forming separate areas (areas 1 to 3 in this embodiment). Understandably, an area could comprise a plurality of AHUs 10. Each AHU comprises a control system 90 adapted to communicate with the network 98. In an embodiment, the first zone is the interior of a building wherein the second zone is the exterior of the same. In other embodiments, the first and the second zones are interiors of either the same or different buildings.

The control system 90 of each AHU 10 uses sensors 9292 to collect data from the components 94 which may represent properties or parameters of the first zone 102, the second zone 104 or the AHU 10 itself. Each controller 90 may send the collected data through the network 98 to a central controller 106, such as, but not limited to, a server, a computer, a tablet, a smartphone or any computerized or computational device. The central controller 106 may also be in communication with each AHU 10.

The central controller 106 may be configured to display or communicate data to a user about one or more zones 102, the performance of the AHUs 10, the quality of exterior 102 air or any other relevant information through a computerized device connected to the network 98.

The central controller 106 may further be configured to receive a request from a user to change possible control parameters and to process and communicate the request or computed action to the AHUs 10. As an example, a request to change the inside temperature of a building may be adjusted or the times of an AHU's 10 sleep timer may be changed to save energy.

In some embodiments, if a first AHU 10 may not connect to the central controller 106, the first AHU 10 may establish a connection with a second reachable AHU 10 in communication with the central controller 106. The second AHU 10 may thus act as an intermediary between the first AHU 10 and the central controller 106 until the connection between the first AHU 10 and the central controller 106 is restored. In another embodiment, the second AHU 10 may also communicate both its data and preceding AHU's 10 data to other AHUs 10 until it reaches one that can reach the central controller 106.

The central controller 106 may further be configured to receive data from external providers 108 such as meteorological stations or toxic airborne agents' alert providers. The central controller 106 may be further configured to control the AHUs 10 when one or more parameters is out of an acceptable range or if an alert is received from such external providers 108. The central controller 106 may be configured to send a request to a plurality or all the AHUs 10 to reduce as much as possible the dangerous impact of external factors. As an example, the central controller 106 may be configured to create a positive pressure in a building by allowing air through a filter adapted to absorb the pollutant or dangerous substance. As an example, the central controller 106 may request all AHUs 10 to operate as inbound blowers and to request application of the filter to all air entering the building. As another example, a central controller 106 may request that the AHUs 10 be configured to block air intake from a building side facing the wind by closing the supply air operation of specific AHUs 10 once an alert of a nearby chemical fire is received. The system 100 may be particularly useful in ventilating a building comprising multiple zones, each zone comprising at least one air AHU 10 as described above. For example, the system may be adapted to be used in agricultural buildings.

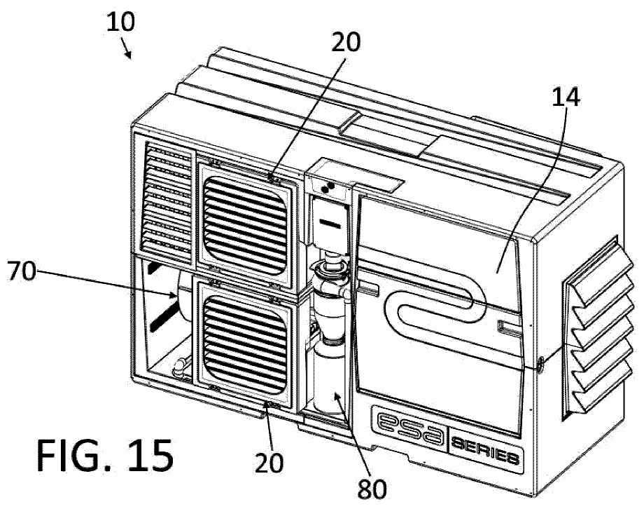

Now referring to FIG. 15, an embodiment of an AHU 10 is shown in a front view. The embodied AHU 10 comprises a filtering system 70, two fan assemblies 20, a vacuum system 80, a controller 40 and closed doors 14 over the cassette region. The viewed face of the AHU 10 may generally be installed towards a zone that is inside a building and may be installed flush with the supporting walls of said building. It may be understood that the shown AHU 10 may comprise any of the features described above.

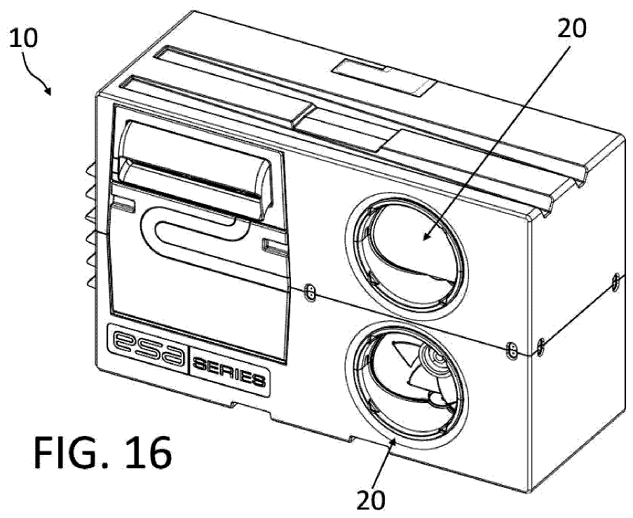

Now referring to FIG. 16, an embodiment of an AHU 10 is shown in a back view. The embodied AHU 10 comprises two fan assemblies. The viewed face of the AHU 10 may generally be installed towards a zone that is outside of a building and may be installed flush with the supporting walls of said building. It may be understood that the shown AHU 10 may comprise any of the features described above.

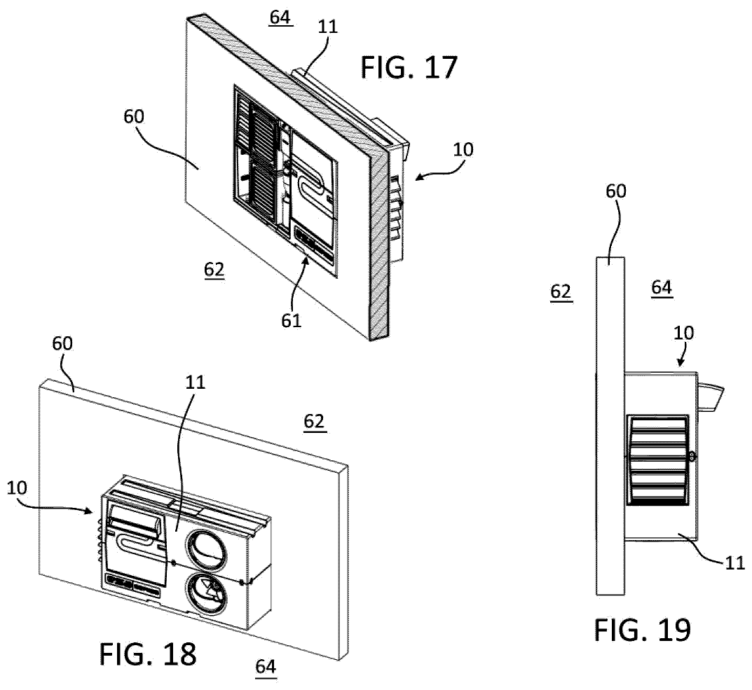

Referring now to FIGS. 17 to 19, an embodiment of an AHU 10 is shown mounted in a wall 60. In such embodiment, the AHU 10 is mounted in an opening 61 of a wall 60 of a building. The AHU 10 is positioned between a first zone 62 and a second zone 64. In a typical use, the first zone 62 is inside the building and the second zone 64 is outside of the building. In the present embodiment, the AHU 10 is flush mounted to the inside wall 60. Access may be provided for maintenance or other purposes through one or more doors 14 positioned on the outside and the inside of the unit 10. In flush mount embodiments, the AHU 10 may protrude from the surface of the wall 60 in contact with the second zone 64. In the shown embodiment, the protuberance of the AHU 10 in the second zone 64 allows having a first inlet/outlet on a side wall and another inlet/outlet on the back wall. Understandably, any other positions of the AHU 10 in the wall 60 are comprised in the scope of the present invention.

While illustrative and presently preferred embodiments of the invention have been described in detail hereinabove, it is to be understood that the inventive concepts may be otherwise variously embodied and employed and that the appended claims are intended to be construed to include such variations except insofar as limited by the prior art.

1) A fan assembly, the fan assembly comprising:
a first conduit;
a housing pivotally attached in the conduit, the housing comprising an intake passage and an outtake passage; and
a fan unit mounted to the housing;
in a first mode, the housing being pivotally oriented to create a first air flow in the first conduit;
in a second mode, the housing being pivotally oriented to substantially limit the air flow in the first conduit.

2) The fan assembly of claim 1, in the second mode, the housing blocking the air flow in the first conduit.

3) (canceled)

4) The fan assembly of claim 1, the fan assembly comprising an enclosure housing the first conduit.

5) (canceled)

6) The fan assembly of claim 1, in a third mode, the housing is being pivotally oriented to create a third air flow in the first conduit in an opposite direction to the first air flow.

7) The fan assembly of claim 1, the fan assembly comprising a second conduit,
in the first mode, the housing further substantially limiting air flow in the second conduit;
in the second mode, the housing creating a second air flow in the second conduit.

8) The fan assembly of claim 7, in the first mode, the housing blocking air flow in the second conduit and in the second mode, the housing blocking the air flow in the first conduit.

9) (canceled)

10) The fan assembly of claim 7, the fan assembly comprising an enclosure housing the first and second conduits.

11) (canceled)

12) The fan assembly of claim 7, in a third mode, the housing being pivotally oriented to create a third air flow in the first conduit, the third airflow being opposite to the first air flow.

13) The fan assembly of claim 12, in a fourth mode, the housing being pivotally oriented to create a fourth air flow in the second conduit, the fourth airflow being opposite to the second air flow.

14) The fan assembly of claim 7, wherein the fan unit is located at an intersection between the first and the second conduit.

15) The fan assembly of claim 1, the fan assembly comprising at least one gas sensor, the sensor being attached to the fan unit, the gas sensor detecting one or more gases characteristics.

16) (canceled)

17) (canceled)

18) The fan assembly of claim 1 further comprising an automatic pivoting mechanism to pivot the housing in relation to the first conduit.

19) (canceled)

20) (canceled)

21) (canceled)

22) (canceled)

23) (canceled)

24) (canceled)

25) (canceled)

26) (canceled)

27) A multi-mode air handling unit (AHU) between a first zone and a second zone, the AHU comprising:
a structure;
a heat exchanger;
a first fan assembly of claim 7 attached to the structure,
the first conduit of the first fan assembly being in fluid communication with a first zone and the heat exchanger and the second conduit of the first fan assembly being in fluid communication with the first zone and the second zone.

28) (canceled)

29) (canceled)

30) (canceled)

31) (canceled)

32) The AHU of claim 27, the pivoting of the housing of the first fan assembly being independent of the pivoting of the housing of the second fan assembly.

33) The AHU of claim 32, the relative pivoting of each of the housing of the first fan assembly and of the second fan assembly allowing distinct operating modes of the AHU.

34) (canceled)

35) The AHU of claim 27, each of the fan assemblies being removable from the AHU.

36) (canceled)

37) A method for alternating between a first air flow mode and a second air flow mode, the method comprising:
pivotally orienting a housing in relation to a first conduit to create a first air flow in the first conduit, the housing comprising a fan unit;
pivotally orienting the housing to limit or block the first air flow in the first conduit.

38) (canceled)

39) (canceled)

40) (canceled)

41) The method of claim 37 used for controlling distinct modes of operation of air handling based on control parameters between two zones, the method comprising:
a controller receiving control parameters from one or more capturing devices;
the controller determining a mode of operation based on the received control parameters;
automatically performing the pivoting of the housing in relation to a first conduit to create or to block the first air flow in the first conduit based on the determined mode of operation.

42) The method of claim 41, the method further comprising automatically performing pivoting the housing to create or block a second air flow in a second conduit while limiting the first air flow in the first conduit based on the determined mode of operation.

43) (canceled)

44) (canceled)

45) (canceled)

46) (canceled)

47) (canceled)

48) (canceled)

49) (canceled)

50) (canceled)

51) (canceled)

52) (canceled)

53) The AHU of claim 27 comprising a second fan assembly of claim 7 attached to the structure, the first conduit of the second fan assembly being in fluid communication with a first zone and the heat exchanger and the second conduit of the second fan assembly being in fluid communication with the first zone and the second zone.
